(19) United States
(12) Patent Application Publication
(10) Pub. No.: US 2015/0013535 A1
(43) Pub. Date: Jan. 15, 2015

(54) ALTERNATIVE CRANKSHAFT MECHANISM

(71) Applicant: John McIntye, Traverse City, MI (US)

(72) Inventor: John McIntye, Traverse City, MI (US)

(21) Appl. No.: 13/937,450

(22) Filed: Jul. 9, 2013

(51) Int. Cl. F02B 75/04

(52) U.S. Cl. CPC F02B 75/04
USPC 92/138

(57) ABSTRACT

The invention is an alternative to existing crankshafts in piston driven internal combustion engines, pumps and gas compressors. The invention comprises a cylinder having both a connection for a piston connecting rod and a shaft to provide for engine related powering applications or applying power to the shaft in piston type pumps and gas compressors. A support bearing is located on the outside diameter of the cylinder. Weight reduction, simple construction, less parts, and cost savings are some of the advantages of the invention.

### FIELD OF INVENTION

The invention relates to piston driven internal combustion engines and the relationship of the crankshaft to utilize the power from the combustion process. In addition, the invention also relates to similar crankshaft relationships of piston driven applications for liquid pumping and gas compression.

### BACKGROUND OF THE INVENTION

Although the basic design of the internal combustion engine is well over a century old, it basically remains the same. In particular, the crankshaft part of the internal combustion engine is very similar to the original internal combustion engines. Piston pumps and gas compressors with crankshafts have adopted similar technology.

### BRIEF SUMMARY OF THE INVENTION

The present invention is an economical alternative to the existing crankshaft component of an internal combustion engine and piston pumps and gas compressors. The invention uses a cylinder that provides for attachment to a piston on one side and the other side has a shaft for power take off. Also the shaft can have power applied thereto to use the invention to reciprocate a piston for a liquid pump or gas compressor. The cylinder outside diameter is surrounded by a bearing surface. The invention is well suited for single cylinder small displacement engines such as model aircraft engines, gasoline powered yard appliances, scooters and motorcycles and piston driven pumps and gas compressors.

### BRIEF DESCRIPTION OF THE SEVERAL VIEWS OF THE DRAWINGS

FIG. 1 is an illustration of a piston with connecting rod and component relationships.

FIG. 2 is an illustration showing an application of powering a propeller.

FIG. 3 is an illustration showing key features.

For purposes of clarity and brevity, like elements and components will bear the same designations and numbering throughout the Figures.

### DETAILED DESCRIPTION OF THE INVENTION

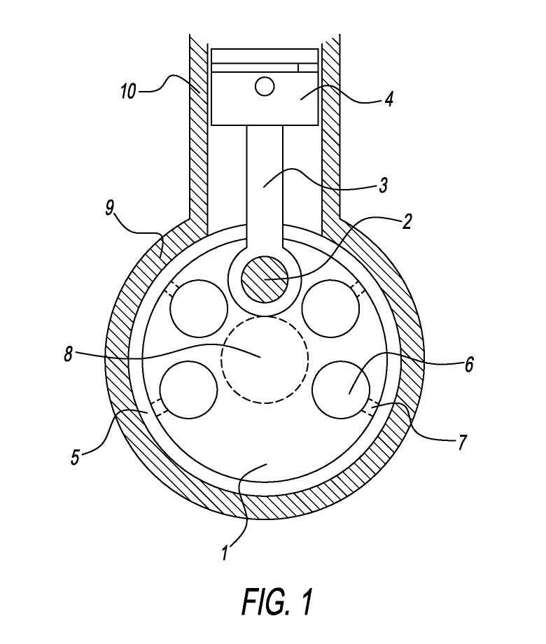

FIG. 1 is a partial cross-sectional view illustrating the piston 4 with its connecting rod 3 affixed to connecting rod stud 2 connected to the cylinder 1. The piston 4 reciprocates within the piston walls 10. The cylinder 1 has voids or blind holes 6 for weight reduction and counterbalancing which have additional holes 7 to provide lubricants to the cylinder 1. The cylinder 1 rotates on the surface of a bushing 5 press fit into body 9 and has a shaft 8 protruding to allow for powering various engine driven applications. The shaft 8 could have power applied from an electric motor to rotate the cylinder 1 to provide reciprocation of the piston 4 for liquid pumping or gas compression applications.

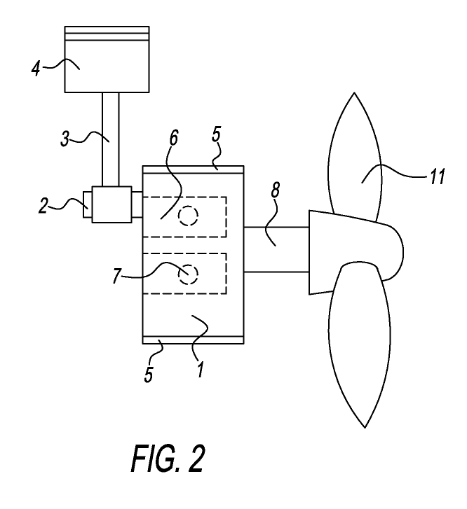

FIG. 2 is a side transparent view of the assembly illustrating the piston 4 with its connecting rod 3 affixed to connecting rod stud 2. The cylinder 1 rotates on bushing 5 surfaces. The cylinder 1 has voids or blind holes 6 for weight reduction and counterbalancing. The voids or blind holes 6 have additional holes 7 to allow lubricant for the cylinder 1. The bushing 5 can be a solid bushing of cast bronze, powdered metal, graphite composite or ceramic type. The bushing 5 can be substituted with a roller, needle or ball bearing type. The cylinder 1 shaft 8 is shown being connected to a propeller 11. The cylinder 1 and shaft 8 can originate from of a single piece of material to enhance strength.

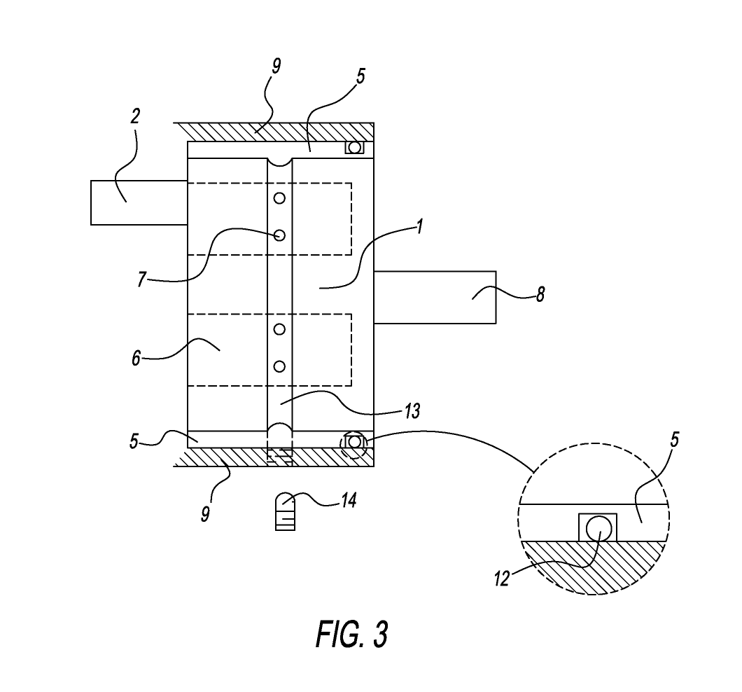

FIG. 3 is a detail cross-sectional view illustrating the cylinder 1 with its outside diameter rotating on the bearing surfaces of the bushing 5. The cylinder 1 features of the connecting rod stud 2 and shaft 8 are shown. Also shown are voids or blind holes 6 for weight reduction and counterbalancing. The voids or blind holes 6 have additional holes 7 for lubricants to the cylinder 1. The bushing 5 is press fit into body 9. The cylinder 1 has a groove 13 machined which allows a ball nose detent 14 to be affixed in body 9 which in turn secures the cylinder 1 and permits only rotational movement. An additional benefit of the detent feature is to prevent the solid bushing from rotating. Lubricant from holes 7 also keeps ball nose detent 14 safe from excessive friction. Also shown is a more detail view of an area in which a solid bushing 5 having a groove for a heat resistant o-ring 12 to be compressed between the bushing 5 and body 9 causing pressure exerted upon the bushing 5 and then sealing cylinder 1. A garter spring or other type of spring used in sealing applications can be substituted for an o-ring.

As compared to existing crankshaft relationships of piston driven applications ranging from internal combustion engines to liquid pumping and gas compression, the invention can be lightweight, have fewer parts, lower production costs and constructed with carbon composites, mechanical grade plastics, ceramics, and/or metals.

Since other modifications and changes varied to fit particular installations and requirements will be apparent to those skilled in the art, the invention is not considered limited to the example chosen for the purposes of disclosure, and covers all changes and modifications which do not constitute departures from the true spirit and scope of the invention.

Having thus described the invention, what is desired to be protected by Letters Patent is presented in the following claims.

The invention claimed is:

1. An alternative crankshaft mechanism comprising:
a. a shaft connected to a cylinder to provide for engine related powering application or a shaft connected to cylinder that has power applied for piston operated pumps and compressors;
b. a cylinder with a connection for a piston connecting rod;
c. a cylinder with an outside diameter machined with a groove which allows a ball nose detent to secure the cylinder and a bushing;
d. a cylinder with interior material voids or blind holes to allow counterbalancing and lightening of the cylinder; and
e. a support bearing or bushing located on the outside diameter of the cylinder.

2. (canceled)

3. The alternative crankshaft mechanism of claim 1 wherein the bushing is machined with a groove for an o-ring or spring to exert pressure upon the bushing to seal the cylinder.

4. The alternative crankshaft mechanism of claim 1 wherein the cylinder and shaft are cast or machined from a single piece of material.

5. (canceled)

6. The alternative crankshaft mechanism of claim 1 wherein voids or blind holes have additional holes leading to the outside diameter of the cylinder to allow for lubricants.
